(19) United States
(12) Patent Application Publication
(10) Pub. No.: US 2013/0159360 A1
(43) Pub. Date: Jun. 20, 2013

(54) INFORMATION PROCESSING APPARATUS, DATA STORAGE METHOD AND COMPUTER-READABLE RECORDING MEDIUM

(71) Applicant: Fujitsu Limited, Kawasaki-shi (JP)

(72) Inventors: Takeshi Miyamae, Kawasaki (JP); Kensuke Shiozawa, Kawasaki (JP)

(21) Appl. No.: 13/664,497

(22) Filed: Oct. 31, 2012

(30) Foreign Application Priority Data
Dec. 19, 2011 (JP) 2011-277556

(51) Int. Cl. G06F 17/30

(52) U.S. Cl. 707/822; 707/E17.005

(57) ABSTRACT

An information processing apparatus includes a unit to store a partial data constituting a part of a processing target file to be stored on an object storage as a new object on an object storage, and to add object management information containing data extent information indicating a position and a size of the partial data within the processing target file, name information representing an object name of the new object and storage sequence information indicating a storage sequence of the new object to update history information on the processing target file; and a unit to read and output readout target data from the object storage on the basis of the readout target extent information and each object management information in the update history information related to the processing target file.

### CROSS-REFERENCE TO RELATED APPLICATIONS

This application is based upon and claims the benefit of priority of the prior Japanese Patent Application No. 2011-277556, filed on Dec. 19, 2011, the entire contents of which are incorporated herein by reference.

### FIELD

The present invention relates to a technology of storing files on an object storage.

### BACKGROUND

As broadly known, there has been utilized a storage called an object storage stored with files as objects. Further, known mapping methods of mapping data to an object on the object storage are a method of mapping the file to the object as done by s3fs and a method of mapping a block (a part of the file) to the object as done by hadoop s3fs (hadoop is a trademark of Apache Software Foundation).

The method of mapping the file to the object has, however, no option but to rewrite the whole file even if desired to rewrite only a part of the file. Furthermore, the method of mapping the block to the object has occurrence of such demerits that the block is of a fixed length, and hence areas are allocated with futility due to a block size being excessively large depending on a work load, and an overhead of communications with a backend cannot be ignored reversely due to the block size being excessively small.

### DOCUMENTS OF PRIOR ARTS

Patent document 1: Japanese Patent Laid-Open Publication No. 2010-218529
Patent document 2: Japanese Unexamined Patent Publication No. 2010-511926

### SUMMARY

According to one aspect of the technology of the disclosure, an information processing apparatus includes a write request response unit to store, each time there is given partial data constituting a part of a processing target file that is to be stored on an object storage, this partial data as a new object on the object storage, and to add object management information containing data extent information indicating a position and a size of the partial data within the processing target file, name information representing an object name of the new object and storage sequence information indicating a storage sequence of the new object on the object storage to update history information related to the processing target file; and a read request response unit to read and output, each time there is given readout target extent information indicating a position and a size, within the processing target file, of the readout target data constituting a part of the processing target file that is to be read from the object storage, readout target data from the object storage on the basis of the readout target extent information and each object management information in the update history information related to the processing target file.

Further, a data storage method according to another aspect of the technology of the disclosure is executed by a computer, the method including: storing, each time there is given partial data constituting a part of a processing target file that is to be stored on an object storage, this partial data as a new object on the object storage; and adding object management information containing data extent information indicating a position and a size of the partial data within the processing target file, name information representing an object name of the new object and storage sequence information indicating a storage sequence of the new object on the object storage to update history information related to the processing target file.

A program according still another aspect of the technology of the disclosure makes a computer execute: a write request response process of storing, each time there is given partial data constituting a part of a processing target file that is to be stored on an object storage, this partial data as a new object on the object storage, and adding object management information containing data extent information indicating a position and a size of the partial data within the processing target file, name information representing an object name of the new object and storage sequence information indicating a storage sequence of the new object on the object storage to update history information related to the processing target file; and a read request response process of reading and outputting, each time there is given readout target extent information indicating a position and a size, within the processing target file, of the readout target data constituting a part of the processing target file that is to be read from the object storage, readout target data from the object storage on the basis of the readout target extent information and each object management information in the update history information related to the processing target file.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is an explanatory diagram of an example of a usage mode of an information processing apparatus according to a first embodiment;

FIG. 2 is an explanatory diagram of an example of a hardware configuration of the information processing apparatus according to the first embodiment;

FIG. 3 is a flowchart of a write request response process executed within the information processing apparatus according to the first embodiment;

FIG. 4A is an explanatory diagram of update history information;

FIG. 4B is an explanatory diagram of the update history information;

FIG. 5 is a flowchart of a read request response process executed within the information processing apparatus according to the first embodiment;

FIG. 6 is an explanatory diagram of contents of the write request response process and the read request response process;

FIG. 7 is a flowchart of a merge process executed within the information processing apparatus according to the first embodiment;

FIG. 8 is an explanatory diagram of one example of a method of calculating an extent count threshold value;

FIG. 9 is a flowchart of the merge process executed within the information processing apparatus according to a second embodiment;

FIG. 10 is a flowchart of the merge process executed within the information processing apparatus according to a third embodiment;

FIG. 11 is a flowchart of the merge process executed within the information processing apparatus according to a fourth embodiment; and

FIG. 12 is a flowchart of a merge process executed within the information processing apparatus according to a fifth embodiment.

### DESCRIPTION OF EMBODIMENTS

In-depth descriptions of embodiments of the present invention will hereinafter be described with reference to the drawings.

### First Embodiment

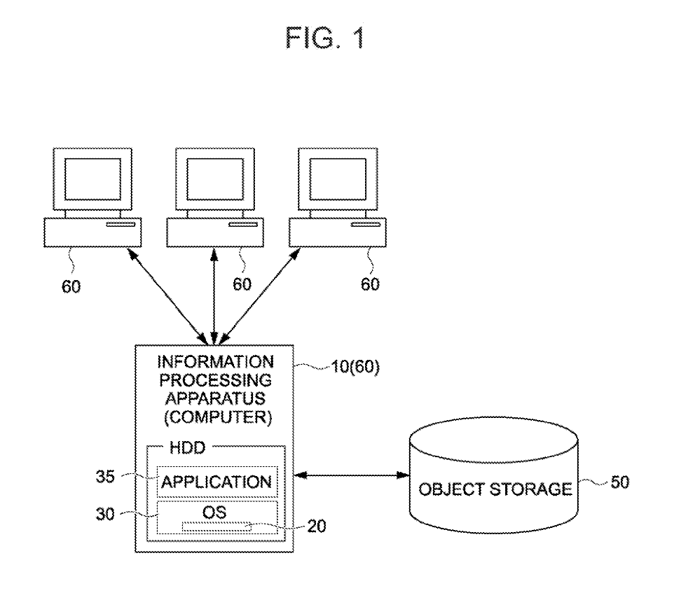

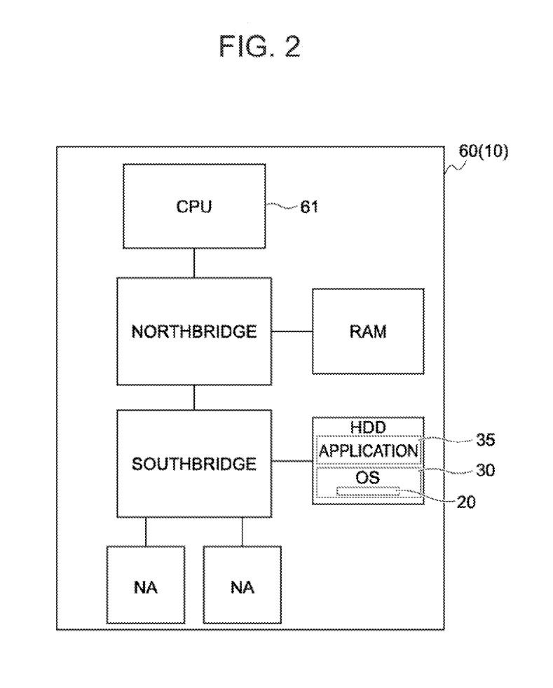

At first, a configuration and a usage mode of an information processing apparatus 10 according to a first embodiment of the present invention will be described by use of FIGS. 1 and 2.

As illustrated in FIG. 1, the information processing apparatus 10 according to the first embodiment is an apparatus connected to an object storage 50 and to some number of clients 60.

The object storage 50 (which will hereinafter be also simply termed the storage 50) is an object storage on the Internet, which is stored with various categories of data (files) as objects. The information processing apparatus 10 is connected to the storage 50 and accesses this storage 50 through HTTP (HyperText Transfer Protocol), in which a part of the object (a part of the data stored as the object) cannot be rewritten but can be read.

Each client 60 connected to the information processing apparatus 10 is a computer used by a user who stores the files on the storage 50.

The information processing apparatus 10 is a computer 60 preinstalled with an OS (Operating System) 30 including a file system 20 and some number of application programs 35 (which will hereinafter be simply referred to as the applications 35).

The file system 20 is a file system (which is a program functioning as a part of the OS in order to handle the data on a physical device as the “file”) developed for realizing the present information processing apparatus 10.

The OS 30 is an existing UNIX-like OS (UNIX is the registered trademark of The Open Group). The application 35 is a POSIX (Portable Operating System Interface)-based program (a database program etc) which requests the OS 30 (the file system 20) to write/read data forming a part of a file. Note that the application 35 is also an existing program. Further, the data requested by the application 35 to be written and read is the data of which a file offset (which is an offset (intra-file position) from an origin, i.e., a start of the file) is an integral multiple of a predetermined value (which will hereinafter be referred to as a block size) and of which a size (data size) is an integral multiple of the block size.

The computer 60 made to function as the information processing apparatus 10 is sufficient if capable of performing communications between the storage 50 and each client 60. Accordingly, the computer 60 can involve using a computer having a hardware configuration as illustrated in, e.g., FIG. 2. To be specific, what can be used as the computer 60 includes, e.g., a CPU (Central ProcessingUnit) 61, a Northbridge, a Southbridge, a RAM (RandomAccess Memory), a HDD (Hard Disk Drive), a NA (Network Adapter), etc. Then, the information processing apparatus 10 is realized by storing the OS 30 including the file system 20 and some number of applications 35 on the HDD of the computer 60 having such a configuration.

Next, functions (operations) of the information processing apparatus 10 will be described. It is to be noted that the CPU 61 executing the respective program is an entity for actually carrying out respective processes, which will be explained later on. In the following discussion, however, contents of the respective processes will be described on the assumption that the program is a subject (in a way that represents the CPU 61 based on the program as the “program”).

When starting the operation of the information processing apparatus 10, each user or an administrator of the information processing apparatus 10 conducts an operation of creating buckets for individual users or a bucket shared with all the users within the storage 50. This operation is performed by setting various categories of information in the storage 50 via input devices of the clients 60 or an input device of the information processing apparatus 10.

Thereafter, each individual user performs an operation of creating a new file within the storage 50 (in the bucket for the user himself or herself or the sharedbucket within the storage 50) and an operation of referring to and updating the files within the storage 50. That is, each user conducts the variety of operations which involve inputting a bucket name of the self-bucket or the shared bucket and a file name of the file to be processed to the information processing apparatus 10 (the applications 35).

When a certain user gives an instruction of creating a new file (when notification of this purport is given from the application 35), the file system 20, similarly to the general UNIX-like file system, determines an mode number of the new file and gets stored with an associated relation between the determined mode number and the file name of the new file.

Further, the application 35, if required to write data of apart of a certain file (which will hereinafter be represented by a processing target file) to the storage 50, outputs a data write request containing items of information and the data (which will hereinafter be represented by a processing target extent) to the file system 20, and these items of information are given as follows:

the bucket name of the bucket to be used for storing the processing target file (the bucket name inputted by the user, which will hereinafter be termed a processing target bucket name);

the file name of the processing target file (the file name inputted by the user, which will hereinafter be termed a processing target file name);

the file offset of the processing target extent; and

the size of the processing target extent.

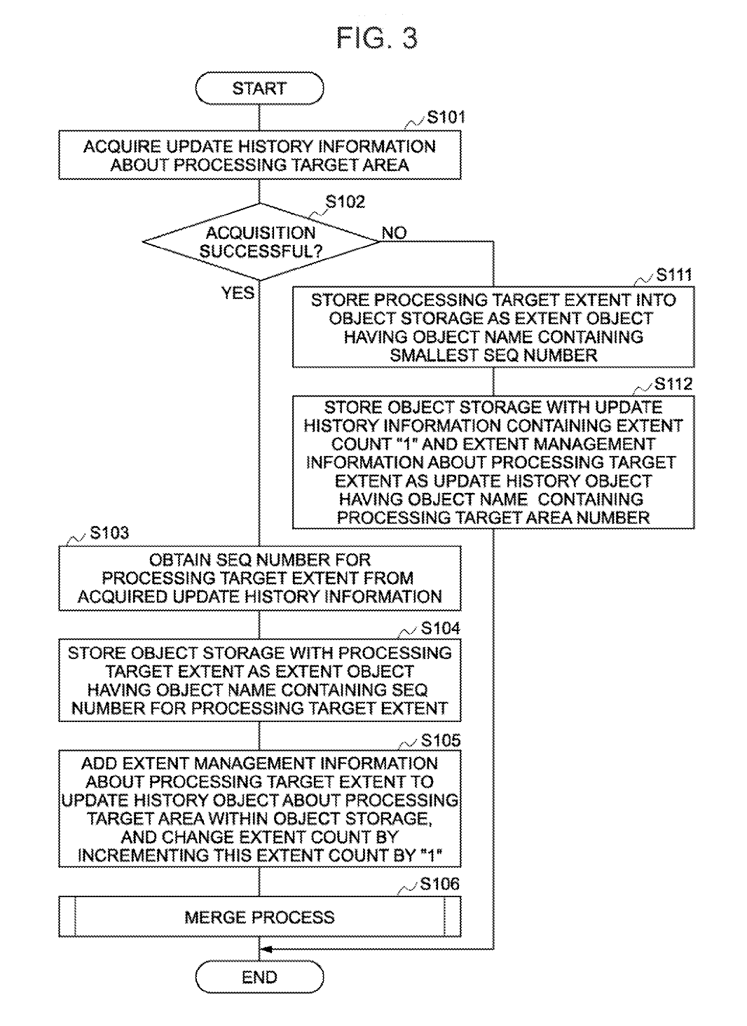

The file system 20 receiving the data write request and the processing target extent executes a write request response process in a procedure illustrated in FIG. 3.

Namely, the file system 20, at first, reads an update history object related to a processing target area from the storage 50, thereby acquiring update history information related to the processing target area (step S101).

Herein, the area connotes a file extent segmented in a position (border) where the file offset comes to an integral multiple of a specified value (e.g., 16 MB). Moreover, the processing target area represents an area of the processing target file that includes the processing target extent (corresponding to the data to be stored on the storage 50). Note that an area number indicating a position (sequential order) within the file is allocated to each area.

The update history object related to the processing target area is an object of the update history information (an in-depth description will be made later on) about the processing target area. The update history object is given the following object name.

<processing target bucket name>_<inode number of processing target file>_<area number of processing target area>

Incidentally, as already described, the data write request received by the file system 20 contains neither the inode number of the processing target file (which will hereinafter be termed the processing target inode number) nor the area number of the processing target area (which will hereinafter be termed the processing target area number). Therefore, when in the process of step S101, the file system 20 specifies (searches for) the processing target inode number from the processing target file name and specifies (calculates) the processing target area number from the file offset of the processing target extent. Then, the file system 20 generates an HTTP request (GET request) for the storage 50 by use of the specified respective numbers and the processing target bucket name, and transmits the generated HTTP request onto the Internet.

The update history object related to a certain area of the processing target file is, however, an object created (stored) on the storage 50 when writing the data in the area of the processing target file for the first time. Accordingly, if the data write request received this time is the first data write request related to the processing target area, the file system 20 cannot acquire the update history information (the update history object) related to the processing target file from the storage 50.

If unable to acquire the update history information on the processing target file (step 102; NO), the file system 20 executes processes in step S111 and step S112.

That is, in this case (step S102; NO), the file system 20, to begin with, stores the processing target extent (the data to be stored on the storage 50) on the storage 50 as an extent object having a following name (step S111).

<processing target bucket name>_<processing target mode number>_<processing target area number>_<smallest SEQ number>

Herein, the smallest SEQ (sequence) number is the predetermined minimum value (e.g., “1”) of the SEQ number.

Subsequently, the file system 20 executes the following process in step S112.

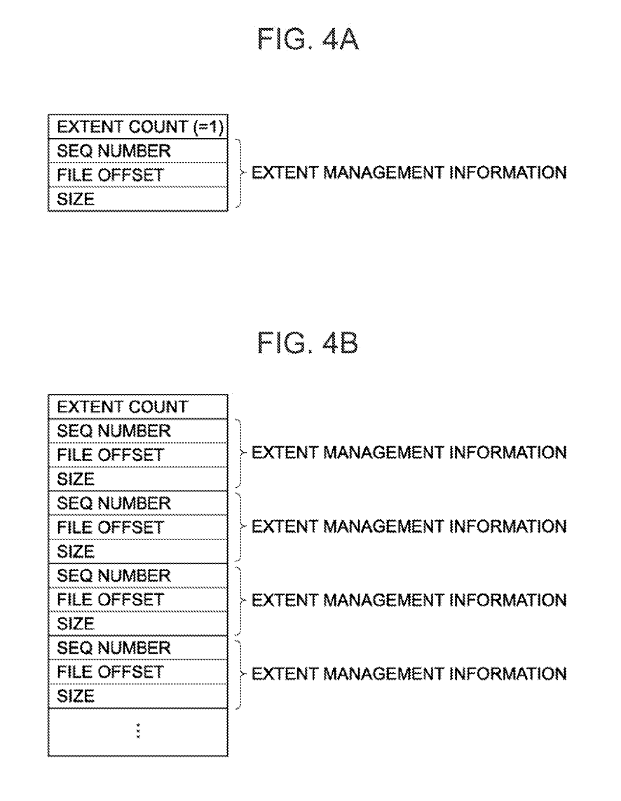

To start with, the file system 20 prepares, on the RAM, the update history information with a sequence of such extent management information that an extent count representing “1” contains the SEQ number used for the name of the extent object stored this time, and the file offset and the size of the processing target extent. That is, the file system 20 prepares the update history information having the configuration (the data structure) depicted in FIG. 4A on the RAM.

Subsequently, the file system 20 stores, on the storage 50, the thus-prepared update history information as an update history object given an object name: “processing target bucket name>_<processing target inode number>_<processing target area number>”.

Then, the file system 20 finishes the process in step S112 and this write request response process (the processes in FIG. 3).

Whereas if the update history information on the processing target area can be acquired from the storage 50 (step S102; YES), the file system 20 starts the processes from step S103 onward. Note that the update history information (the update history object) is, as will be described later on (refer to step 105), the information to which the extent management information is added on a per data write request basis. Accordingly, the update history information, which undergoes referring/updating when in each of the processes from step S103 onward, normally contains plural items of extent management information as illustrated in FIG. 4B.

If the update history information on the processing target area can be acquired from the storage 50 (step S102; YES), the file system 20 executes at first a process of obtaining the SEQ number for the processing target extent on the basis of the update history information (step S103). The SEQ number for the processing target extent, which is obtained in the process of step S103, is the SEQ number used as a part of the object name of the extent object with respect to the processing target extent. In the process of step S103, a larger value (which is given by the maximum value of the SEQ number in the update history information plus “1” (maximum value+1) in the first embodiment) than any SEQ numbers contained in the update history information (see FIGS. 4A and 4B), is obtained as the SEQ number for the processing target extent.

The file system 20 obtaining the SEQ number for the processing target extent stores the processing target extent as the extent object having a following object name on the storage (step S104).

<processing target bucket name>_<processing target mode number>_<processing target area number>_<SEQ number for processing target extent>

Note that the objects stored on the storage 50 by the file system 20 are only objects each having a name: <bucket name>_<inode number>_<area number> or <bucket name>_<inode number>_<area number>_<SEQ number>. Accordingly, in this step S104 or step S111 described above, the processing target extent is stored on the storage 50 not as the object in place of the existing object but as a new object.

The file system 20 finishing the process of step S104 adds, to a tail (end) of the update history information, the extent management information containing the SEQ number for the processing target extent and the file offset and the size of the processing target extent (step S105). Moreover, the file system 20 increments the extent count of the update history information by “1”, to which the extent management information has been added (step S105).

Thereafter, the file system 20 stores, on the storage 50, the update history information with its contents being updated as the update history object whose name is <processing target bucket name>_<processing target mode number>_<processing target area number> (step S105).

Incidentally, it is the case to execute the process in this step S105, in which to enable the read of the object having the name such as: <processing target bucket name>_<processing target inode number>_<processing target area number> (step S102; YES). Therefore, in step S105, it follows that the update history object in the storage 50 with respect to the processing target area is changed (rewritten) into an object specified by “the update history information to which the extent management information is added and of which the extent count is incremented by “1””.

The file system 20 finishing the process in step S105 executes a merge process (step S106; details thereof will be described later on) and thereafter terminates the write request response process.

Next, an operation of the file system 20 in response to the data read request will be discussed.

The application 35, when required to read the data of the part of the processing target file (which will hereinafter be referred to as the read target data) from the storage 50, outputs a data read request containing items of information to the file system 20. These items of information are given as follows:

the processing target bucket name (the bucket name of the bucket stored with the processing target file);

the processing target file name (the file name of the processing target file);

the file offset of the read target data; and

the size of the read target data.

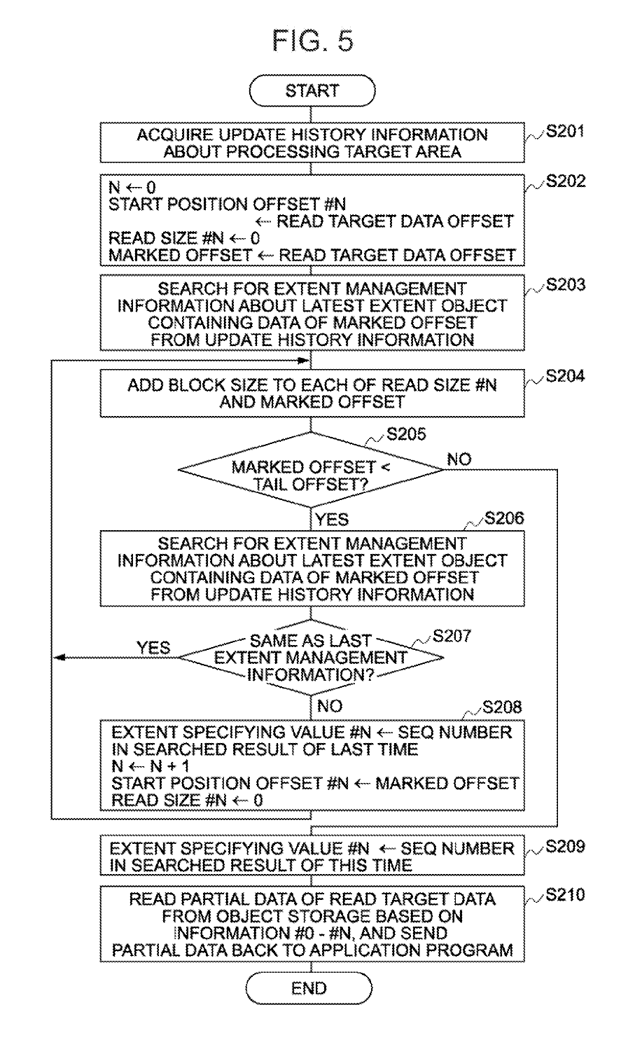

The file system 20 receiving this data read request executes a read request response process in a procedure illustrated in FIG. 5. Note that in FIG. 5 and in the following discussion, a tail offset connotes a file offset of the tail (end) data of the read target data.

Namely, the file system 20 receiving the data read request acquires, at first, the update history information on the processing target area (which will hereinafter be simply termed the update history information) from the storage 50 (step S201). Note that the process in this step S201 is the process having the same content as the process in step S101 has. Further, though an illustration in the flowchart (FIG. 5) is omitted, if unable to acquire the update history information from the storage 50, the file system 20 notifies the application 35 of a purport that the read target data does not exist (a so-called an ENOENT error (an error message “No such file or directory”)), and thereafter finishes the read request response process.

The file system 20 finishing the process in step S201 initializes a variety of variables used (undergoing referring/updating) in the subsequent processes (step S202). To be specific, the file system 20, after setting “0” in N, sets “0” in a read size #N (i.e., a read size #0) (step S202). Further, the file system 20 sets the file offset (the read target data offset in FIG. 5) of the read target data respectively in a start position offset #N (i.e., a start position offset #0) and a marked offset (step S202).

Thereafter, the file system 20 searches for the extent management information on the latest extent object containing the data of the marked offset from the update history information (the update history information on the processing target area that has already been acquired from the storage 50) (step S203).

Note that as apparent from the content of the write request response process (FIG. 3) already described, the SEQ number in a certain piece of extent management information represents a storage sequence of the associated extent object (specified by the SEQ number, the processing target mode number, etc). Further, the file offset and the size in a certain piece of extent management information indicate an extent (a position and a length) within the processing target file of the data retained by the associated extent object. Accordingly, the process, which is actually executed in step S203, is a process of searching for the extent management information with the largest SEQ number, in which the marked offset is interposed between the file offset and a set of the file offset and the size (file offset+size), from the update history information. Note that though an illustration in the flowchart is omitted, if unable to search for the extent management information satisfying the condition given above from the update history information, the file system 20 finishes the read request response process after notifying the application 35 of the purport that the read target data does not exist.

The file system 20 finishing the process in step S203 adds the block size to the read size #N and the marked offset, respectively (step S204). Thereafter, the file system 20 determines whether or not the marked offset after the addition of the block size is smaller than the tail offset (the file offset of the tail data of the read target data) (step S205).

If the marked offset is smaller than the tail offset (step S205; YES), the file system 20 again searches for the extent management information about the latest extent object containing the data of the marked offset from the update history information (step S206). Note that also if failing in the search in this step, the file system 20 notifies the application 35 of the purport that the read target data does not exist and thereafter terminates the read request response process.

The file system 20 finishing the process in step S206 determines whether or not the searched extent management information is the same as the extent management information which has been searched for last time, and, if being the same (step S207; YES), starts the processes from step S204 onward.

Whereas if the extent management information being searched for this time is not the same as the extent management information being searched for last time (step S207; NO), the file system 20 stores the SEQ number contained in the extent management information being searched for last time as an extent specifying value #N and thereafter adds “1” to N (step S208). Moreover, in this step S208, the file system 20 also executes the process of storing the value of the marked offset at that point of time as the start position offset #N and the process of storing “0” as the read size #N.

Then, the file system 20 finishing the process in step S209 starts the processes from step S204 onward.

The file system 20, if the marked offset after the addition of the block size becomes equal to or larger than the tail offset (step S205; NO), stores the SEQ number contained in the extent management information being searched for this time as the extent specifying value #N (step S209).

In subsequent step S210, the file system 20 executes a process of reading, from the storage 50, the data of a portion indicated by the start position offset #N and the read size #N of the extent object having a name given such as: <processing target bucket name>_<processing target mode number>_<processing target area number>_<extent specifying value #N> with respect to each of n-values from 0 to N. More specifically, the file system 20 carries out a process of generating and transmitting a so-called extent request (partial GET request) “N+1” times on the basis of the information described above, and receiving response data in response to each request.

Then, the file system 20 transmits the data (i.e., the read target data) assembled by connecting respective pieces of readout data (the received response data) back to the application 35, and thereafter finishes the process in step S210 and the read request response process.

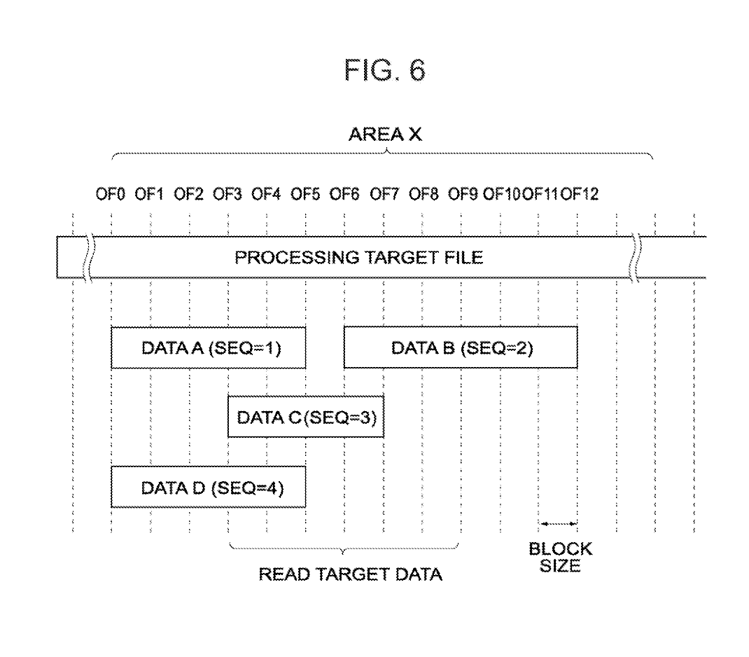

Herein, the contents of the write request response process and the read request response process described so far are to be described more specifically by use of FIG. 6. Note that in FIG. 6 and in the following discussion, an area X represents an area to which an area number X is allocated.

As already explained (see FIG. 3), the file system 20, in the case of receiving the write request for a certain item of data, without checking whether or not this data is the update data of the data that has already been stored on the storage 50, stores the storage 50 with this data as the extent object having the name containing the SEQ number indicating the storage sequence (the storage sequence on an area-by-area basis) on the storage 50.

Therefore, for instance, data A through data D in the extent (a set of consecutive blocks) illustrated in FIG. 6 within the area X of the processing target file are written in this sequence, in which case with respect to the data A the extent object having the name containing the SEQ number 1 is stored (generated) on the storage 50. Further, with respect to the data B, the extent object having the name containing the SEQ number 2 is stored on the storage 50, and, with respect to the data C, the extent object having the name containing the SEQ number 3 is stored on the storage 50. Then, in regard to the data D, the extent object having the name containing the SEQ number 4 is stored on the storage 50.

Moreover, the file system 20, on the occasion of generating the extent object about a certain item of data on the storage 50, adds the extent management information having the contents, which have already been explained, to the update history object related to the area including this very data.

Accordingly, in a case where the extent objects of the data A through the data D are stored on the storage 50, the update history objects (the update history information) related to the area X contain four items of extent management information. These four items of information are given as follows:

the extent management information A in which to set the file offset (indicated by OF0 in FIG. 6) and the size of the data A having the SEQ number 1;

the extent management information B in which to set the file offset (indicated by OF6 in FIG. 6) and the size of the data B having the SEQ number 2;

the extent management information C in which to set the file offset (indicated by OF3 in FIG. 6) and the size of the data C having the SEQ number 3; and

the extent management information D in which to set the file offset (indicated by OF0 in FIG. 6) and the size of the data D having the SEQ number 4.

Under such circumstances, in the case of receiving the data (the “read target data” in FIG. 6) read request for 6 blocks counted from OF3, the file system 20 executes the following process.

The file system 20, at first, acquires the update history information related to the area A (step S201 in FIG. 5).

Subsequently, the file system 20 conducts setting as follows (step S202):

N←0;

the start position offset #0←OF3 (the file offset of the read target data);

the read size #0←0; and

the marked offset←OF3 (the file offset of the read target data).

Then, the file system 20 searches for the extent management information with the largest SEQ number, in which the marked offset is interposed between the file offset and a set of the file offset and the size (file offset+size), from the update history information (step S203). If the update history information has the contents described above and if the marked offset is OF3, each of the extent management information A, the extent management information C and the extent management information D corresponds to “the extent management information in which the marked offset is interposed between the file offset and a set of the file offset and the size (file offset+size)”. Then, the extent management information D has the largest SEQ number among these pieces of extent management information A, C and D and is therefore searched for in step S203.

In subsequent step S204, the file system 20 changes the read size #0 being “0” so far into a block size and changes the marked offset being OF3 so far into OF4.

Then, the marked offset (=OF4) is smaller than the tail offset (=OF9−1) (step S205; YES), and hence the file system 20 executes the process in step S206.

Also if the update history information has the contents described above and if the marked offset is OF4, each of the extent management information A, the extent management information C and the extent management information D corresponds to “the extent management information in which the marked offset is interposed between the file offset and a set of the file offset and the size (file offset+size)”. Then, the extent management information D has the largest SEQ number among these pieces of extent management information A, C and D and is therefore searched for in step S206.

The extent management information being searched for last time is also the extent management information D (step S207; YES), and therefore the file system 20 changes the read size #0 into a 2× block size and changes the marked offset into OF5 (step S204).

Then, the marked offset (=OF5) is smaller than the tail offset (step S205; YES), and hence the file system 20 executes the process in step S206. If the update history information has the contents described above and if the marked offset is OF5, only the extent management information D corresponds to “the extent management information in which the marked offset is interposed between the file offset and a set of the file offset and the size (file offset+size)”. Therefore, in the process of step S206, the extent management information C is searched for.

Then, because of searching for the extent management information C different from the extent management information D being searched for last time (step S207; NO), the hence the file system 20 performs the following setting in step S208:

the extent specifying value #0←4 (the SEQ number in the searched results of the last time);

N←1 (=N+1);

the start position offset #1←OF5 (the marked offset at that point of time); and

the read size #1←0.

Thereafter, the file system 20 loops back to step S204 and iterates the same processes. Then, it is when the marked offset=OF9 that a relation “marked offset≧tail offset” is established after the addition of the block size, and hence, upon completing the process in step S209, it follows that there is realized a status where the file system 20 retains the following items of information.

### N:2

Extent specifying value#0:4
Start position offset #0:OF3
Read size #0:2× block size
Extent specifying value #1:3
Start position offset #1:OF5
Read size #1:2× block size
Extent specifying value #2:3
Start position offset #2:OF7
Read size #2:2× block size

Thus (the reference to FIG. 6 is also desired to be made), the extent specifying value #n (n=0 to N) obtained in the procedure described above corresponds to the SEQ number given in the name of the extent object which retains the latest data starting from the start position offset #n and having its size that is the read size #n.

Accordingly, with respect to each of the n-values from to N, the data of the portion, specified by the start position offset #n and the read size #n, of the extent object with the name containing the extent specifying value #n, is read from the storage 50, and the readout data is transmitted back to the application 35 (step S210), and it follows that it is feasible to respond to the data read request given from the application 35.

Next, a content of the merge process executed in step S106 of the write request response process (FIG. 3) will be described. Note that in the following discussion, the update history information connotes the update history information on the processing target area, of which the contents are updated in the process of step S105. Further, the block connotes an extent of the file delimited at a portion (border) where the file offset becomes an integral multiple of the block size.

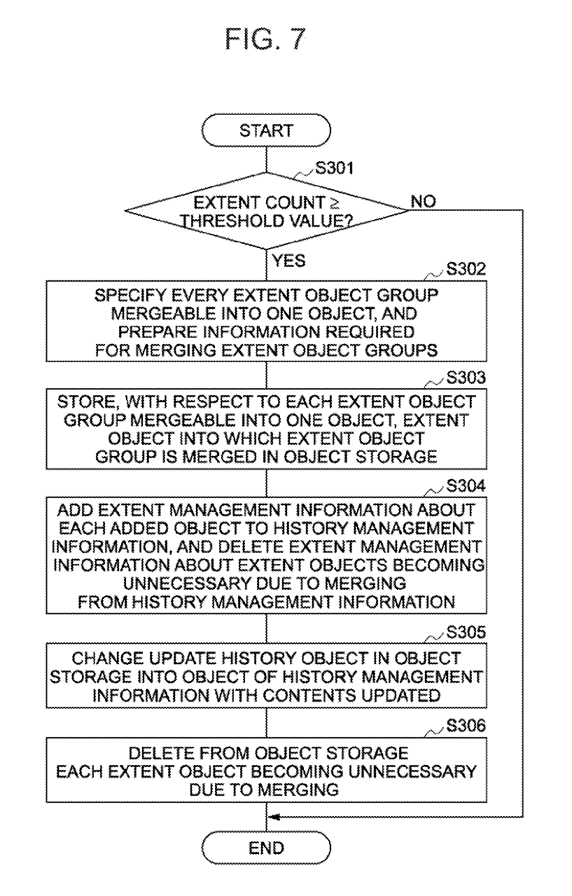

FIG. 7 depicts a flowchart of the merge process.

This merge process is a process aiming at efficiently reading/writing the update history object and deleting a futile extent object from within the storage 50.

As illustrated in FIG. 7, the file system 20 starting the merge process, at first, determines whether or not the extent count in the update history information is equal to or larger than an extent count threshold value (the threshold value in FIG. 6) (step S301).

The extent count threshold value is a value that is preset as a lower limit value of the extent count with which the update history object cannot be efficiently read/written. The value of this extent count threshold value can be obtained, e.g., in the following procedure.

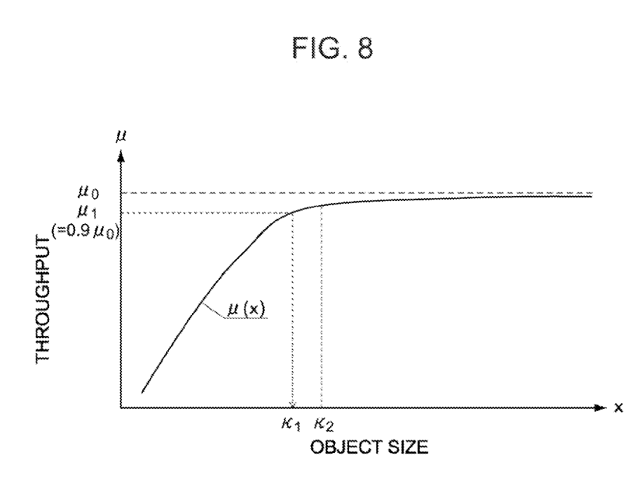

To begin with, the objects having the variety sizes are written to and read from the storage 50 by use of the information processing apparatus 10 (the computer 60), thereby obtaining an object size throughput curve representing a relation between the object size x and a throughout. Then, an object size throughput curve μ(x) taking a shape as illustrated in FIG. 8 is obtained.

Namely, in the object size throughput curve μ(x) of the storage 50, the throughput continues to rise till the object size x reaches a fixed value but becomes approximate to a limit value μ₀ when the object size x exceeds the fixed value.

The shape of this object size throughput curve μ(x) implies that the efficiency becomes better till the object size x reaches the fixed value, however, a latency becomes poorer as the object size x increases when the object size x exceeds the fixed value.

It is therefore desirable, it follows, that the size of the update history object undergoing the frequent reading and writing is equal to or smaller than the size with the throughput being about 90% (μ₁) of the limit value μ₀. Then, the size of the update history object is substantially a size given by “an extent management information count×the single extent management information” (see FIG. 4B). Hence, there is calculated a value obtained by dividing a minimum value κ₂ that is an integral multiple of the block size being κ₁ or equal to or larger than κ₁, and, if integerizing the calculated result, the extent count threshold value can be obtained.

Referring back to FIG. 7, the description of the merge process continues.

If the extent count is smaller than the extent count threshold value (step S301; NO), the file system 20 terminates this merge process (the write request response process in FIG. 3) without executing any process particularly.

Whereas if the extent count is equal to or larger than the extent count threshold value (step S301; YES), the file system 20 specifies, based on the update history information, all the extent object groups mergeable with one object and prepares information required for merging each specified extent object group (step S302). Thereafter, with respect to every specified extent object group, the file system 20 stores, based on the prepared information, the extent object merged with the extent object group on the storage 50 (step S303).

The contents of step S302 and step S303 will hereinafter be described more specifically. Note that in the following discussion, a data extent represents an extent of the processing target file, which is specified by the file offset and the size contained in the extent management information.

The file system 20 executes, in step S302, processes given in the following items [1] and [2] (2a or 2b) on a block-by-block basis of the processing target area.

[1] A process of searching for the extent management information where the data extent contains a processing target block (which will hereinafter be referred to as the processing target block).

[2a] A process of storing, if failing in searching, a specified value (e.g., “−1”) as a status value of the processing target block (the status value associated with the file offset of the processing target block).

[2b] A process of storing, if one or more pieces of extent management information can be searched for, the largest value of the SEQ number in one or more pieces of extent management information as the status value of the processing target block, and also storing the SEQ number of each piece of extent management information as a delete required SEQ number.

Note that the process of storing the delete required SEQ number in the process [2b] described above is a process executed without being related to the processing target block and is also a process that is omitted if the same SEQ number has already been stored as the delete required SEQ number.

Further, the file system 20 carries out the following process in step S303.

To start with, the file system 20 specifies all the block groups with their status values not being the specified values (i.e., with their status values being the SEQ numbers) on the basis of the status values related to the respective blocks that are obtained in the process of step S302. Note that when in this process, the file system 20 specifies “one block with the status value being different from that of a neighboring block” also as “the consecutive block group with the status value not being the specified value”.

Subsequently, the file system 20, with respect to every specified block group, executes “a process of reading the respective items of data indicated by the status values from the storage 50, and storing the data assembled by connecting these items of readout data on the storage 50 as a new extent object”.

A content of this process (which will hereinafter be termed a merge object storing process) will hereinafter be described based on a concrete example.

For example, a data write status is as illustrated in FIG. 6, the status values related to the respective blocks, which are obtained in the process of step S302, become the following values:

4, 4, 4, 4, 4, 3, 3, 2, 2, 2, 2, 2, specified value (e.g., −1), . . . .

Note that the first status value “4” is the status value of the block of which the file offset is OF0.

The file system 20 specifies, from this result, 12 block groups with their status values being 4, 4, 4, 4, 4, 3, 3, 2, 2, 2, 2, 2 as the consecutive block groups with the status values not being the specified values (which will hereinafter be referred to as data consecutive block groups). Note that the file system 20 also specifies the data consecutive block groups with respect to the blocks in extents not illustrated in FIG. 6.

Then, the file system 20, with respect to every thus specified data consecutive block group, performs the merge object storing process having the following content.

The file system 20 starting the merge object storing process with respect to a certain data consecutive block group at first segments this data consecutive block group into some number of consecutive object identical block groups with their status values being the same. Note that the file system 20 deals with “one block with the status value being different from that of the neighboring block” as the object identical block group, and segments the data consecutive block group into some number of object identical block groups.

Accordingly, the data consecutive block group including the 12 blocks described above is segmented into 3 object identical block groups given as follows:

the first object identical block group including the blocks (the five blocks of which the file offsets are OF0 through OF4) with the status values being “4, 4, 4, 4, 4”;

the second object identical block group including the blocks (the two blocks of which the file offsets are OF5 and OF6) with the status values being “3, 3”; and

the third object identical block group including the blocks (the five blocks of which the file offsets are OF7 through OF11) with the status values being “2, 2, 2, 2, 2”.

Subsequently, the file system 20 executes a process of reading, with respect to every object identical block group, the data indicated by this object identical block group from the storage 50.

To be specific, with respect to the first object identical block group, the file system 20 reads, from the storage 50, the data for the five blocks counted from the file offset OF0 in the extent object identified by the SEQ number 4 (and the processing target mode number etc). Further, with respect to the second object identical block group, the file system 20 reads, from the storage 50, the data for the two blocks counted from the file offset OF7 in the extent object identified by the SEQ number 3. Moreover, with respect to the third object identical block group, the file system 20 reads, from the storage 50, the data for the five blocks counted from the file offset OF7 in the extent object identified by the SEQ number 2.

Thereafter, the file system 20 stores the storage 50 with the data assembled by connecting the respective items of data read from the storage 50 as the extent object having the object name. The object name is given such as: <processing target bucket name>_<processing target mode number>_<processing target area number>_<largest value of existing SEQ number+1>.

Note that the existing SEQ number represents the SEQ number contained in the update history information and the SEQ number used when in the merge object storing process that has already been executed in the process of step S303 of this time.

Then, the file system 20 finishes the merge object storing process for a certain (one) data consecutive block group.

The file system 20 finishing the process (the process including the merge object storing processes executed some number of times) in step S303, adds the extent management information about each object added to within the storage 50 in the process of step S303 to the update history information (step S304). Incidentally, as already explained (defined), the update history information, to which the extent management information is added in this step S304, is the update history information acquired by the file system 20 from the storage 50 and having the contents changed also by the file system 20.

Further, in step S304, the file system 20 deletes the extent management information (the extent management information indicated by “SEQ number=delete required SEQ number”) about each extent object becoming unnecessary due to merging out of the update history information.

The extent management information is deleted in this step S304 by rewriting the extent management information to be deleted in the update history information into information recognized not to be the extent management information (which will hereinafter be referred to as non-use area information). Further, the extent management information is added in step S304 by rewriting, if the update history information contains the non-use area information, the non-use area information into the extent management information and by adding, whereas if the update history information contains none of the non-use area information, the extent management information to the tail of the update history information.

Moreover, the file system 20 also executes a process of adding a value (this value is a minus value) obtained by “added update history information count deleted update history information count” to the extent count in the update history information (step S304).

Thereafter, the file system 20 changes the update history object related to the processing target area in the storage 50 into an object of the update history information with the contents updated (step S305). Then, the file system 20 deletes the extent objects (the extent objects identified by the respective delete required SEQ numbers) becoming unnecessary due to merging from the storage 50 (step S306), and thereafter finishes this merge process (and the write request response process in FIG. 3).

As described in detail so far, the information processing apparatus 10 (the file system 20) according to the first embodiment is configured to enable each individual user to realize an environment where the storage 50 can be used as the storage in which the part of the object can be rewritten. Accordingly, in the case of using the information processing apparatus 10 (the file system 20) according to the first embodiment, it follows that the storage 50 can be used in the form of not causing any inconvenience when mapping the file to the object and when mapping the block to the object. Moreover, the use of the information processing apparatus 10 (the file system 20) enables the storage 50 to be employed as the storage with no restriction in terms of the storable file size.

Further, the information processing apparatus 10 (the file system 20) according to the first embodiment has the function of performing the merge process. Therefore, it follows that the information processing apparatus 10 (the file system 20) according to the first embodiment can prevent the storage capacity of the storage 50 from being used with excessive futility.

### Second Embodiment

An information processing apparatus according to a second embodiment of the present invention is an apparatus configured to replace the file system 20 within the information processing apparatus 10 according to the first embodiment with what executes the merge process having contents different from those described above. Therefore, the following discussion will explain only the contents of the merge process executed by the file system 20 within the information processing apparatus 10 according to the second embodiment by use the same reference numerals and symbols as those employed when describing the information processing apparatus 10 of the first embodiment.

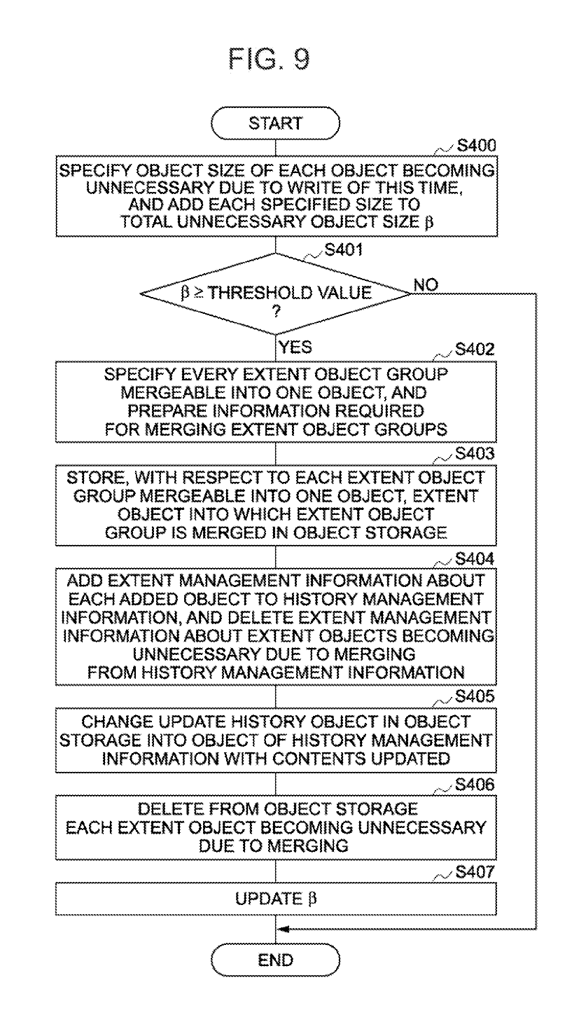

FIG. 9 illustrates a flowchart of the merge process executed by the file system 20 (which will hereinafter be termed the second file system 20) within the information processing apparatus 10 according to the second embodiment.

As illustrated in FIG. 9, the second file system 20 starting the merge process, at first, executes a process of specifying an object size of the objects becoming unnecessary due to the write of this time and adds the specified object size to a total unnecessary object size β related to the processing target area (step S400)

Herein, the object size of the objects becoming unnecessary due to the write of this time is a total size of a part of some number of extent objects not being unnecessary before being written this time but becoming unnecessary due to the write of this time.

Further, the total unnecessary object size β connotes numerical value information managed by the second file system 20 on a per area (and file) basis and representing the total unnecessary object size (the total size of the data in which the update data exists within the storage 50).

Note that the second file system 20, when writing the data in a certain area for the first time, initializes the total unnecessary object size β related to this area to “0”. Moreover, when rebooting the information processing apparatus 10, the second file system 20, on the occasion of acquiring the update history information on a certain area for the first time after rebooting, specifies the total unnecessary object size related this area by analyzing the acquired update history information. Then, the second file system 20 sets the specified result in the total unnecessary object size β related to this area.

The second file system 20 finishing the process in step S400 determines whether or not the total unnecessary object size β exceeds a total unnecessary object size threshold value (“threshold value” in FIG. 9) (step S401). Herein, the total unnecessary object size threshold value connotes a value (a value changeable for the administrator) set for the second file system 20 by operating an input device of the information processing apparatus 10. Note that the total unnecessary object size threshold value can be also set to a value (which is, e.g., ten times as large as the maximum size of the extent object) which changes depending on other conditions.

If the total unnecessary object size β is less than the total unnecessary object size threshold value (step S401; NO), the second file system 20 finishes this merge process without executing any process particularly.

Whereas if the total unnecessary object size β is less than the total unnecessary object size threshold value (step S401; YES), the second file system 20 executes the same processes in steps S402-S406 as those in steps S302-S306 (FIG. 7).

Then, the second file system 20 finishing the process in step S406 updates the total unnecessary object size β into a value (i.e., “0”) representing a present status (step S407), and thereafter finishes this merge process.

As described above, the information processing apparatus 10 (the file system 20) according to the second embodiment is different from the information processing apparatus 10 (the file system 20) according to the first embodiment in terms of only the contents of the merge process. Then, the merge process having the contents/procedure depicted in FIG. 9 can prevent the storage capacity of the storage 50 from being used with the excessive futility. It can be therefore said that the information processing apparatus 10 (the file system 20) according to the second embodiment exhibits the same operational effects as those of the information processing apparatus 10 (the file system 20) according to the first embodiment.

### Third Embodiment

An information processing apparatus according to a third embodiment of the present invention is an apparatus configured to replace the file system 20 within the information processing apparatus 10 according to the first embodiment with what executes the merge process having contents different from those described above. Therefore, similarly to when describing the second embodiment, the following discussion will explain only the contents of the merge process executed by the file system 20 within the information processing apparatus 10 according to the third embodiment by use the same reference numerals and symbols as those employed when describing the information processing apparatus 10 of the first embodiment.

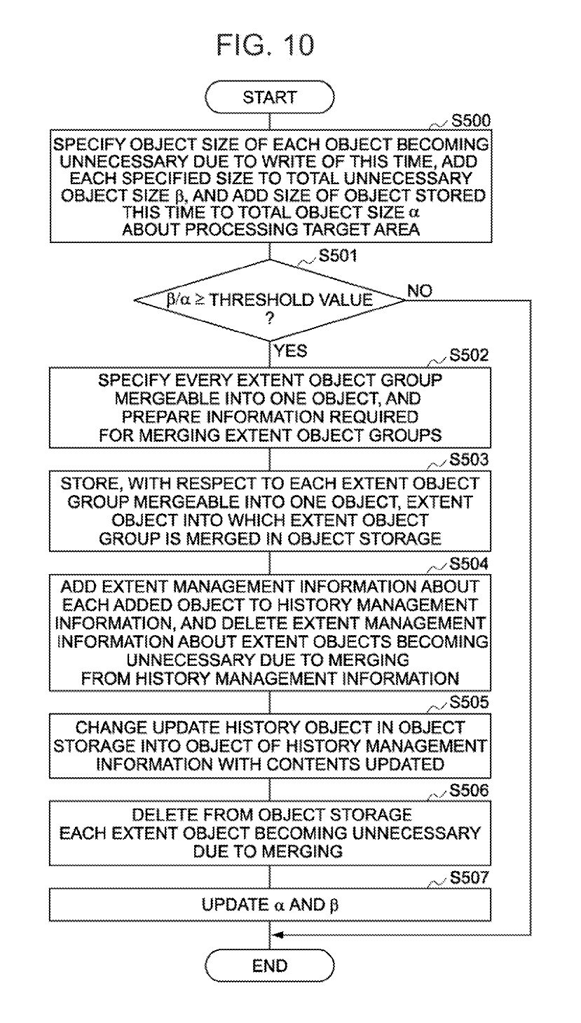

FIG. 10 illustrates a flowchart of the merge process executed by the file system 20 (which will hereinafter be termed the third file system 20) within the information processing apparatus 10 according to the third embodiment.

As illustrated in FIG. 10, the third file system 20 starting the merge process, at first, in the same way as the second file system 20 does, adds the object size of the objects becoming unnecessary due to the write of this time to the total unnecessary object size β related to the processing target area (step S500). The third file system, however, executes also in this step S500) a process of adding the object size (precisely the size of the processing target extent that is stored on the storage 50 as the object this time) stored this time to a total object size α about the processing target area.

Herein, the total object size α connotes a total size of the extent data managed on the per area (and file) basis by the third file system 20 and stored as the object on the storage 50. The third file system 20, when writing the data in a certain area for the first time, initializes the total object size α related to this area to “0”. Moreover, when rebooting the information processing apparatus 10, the third file system 20, on the occasion of acquiring the update history information on a certain area for the first time after rebooting, calculates a total sum of the respective sizes in the acquired update history information. Then, the third file system 20 stores the calculated result as the total object size α related to this area.

The third file system 20 finishing the process in step S500 determines whether or not a value given by β/α (a value obtained by dividing β by α) exceeds a ratio threshold value (“threshold value” in FIG. 10; e.g., 0.9) (step S501). This ratio threshold value also, similarly to the total unnecessary object size threshold value described above, connotes a value (a value changeable for the administrator) set for the third file system 20 by operating the input device of the information processing apparatus 10.

If the β/α value is smaller than the ratio threshold value (step S501; NO), the third file system 20 finishes this merge process without executing any process particularly.

Whereas if the β/α value is equal to or larger than the ratio threshold value (step S501; YES), the third file system 20 executes in steps S502-S506 the same processes as those in steps S302-S306 (FIG. 7).

Then, the third file system 20 finishing the process in step S506 updates the values of α and β into values each representing the present status (step S507), and thereafter terminates this merge process.

As described above, the information processing apparatus 10 (the file system 20) according to the third embodiment is different from the information processing apparatus 10 (the file system 20) according to the first embodiment in terms of only the contents of the merge process. Then, the merge process having the contents/procedure depicted in FIG. 10 can prevent the storage capacity of the storage 50 from being used with the excessive futility. It can be therefore said that the information processing apparatus 10 (the file system 20) according to the third embodiment exhibits the same operational effects as those of the information processing apparatus 10 (the file system 20) according to the first embodiment.

### Fourth Embodiment

An information processing apparatus according to a fourth embodiment of the present invention is an apparatus configured to replace the file system 20 within the information processing apparatus 10 according to the first embodiment with what executes the merge process having contents different from those described above. Therefore, the discussion will explain only the contents of the merge process executed by the file system 20 within the information processing apparatus 10 according to the fourth embodiment by use the same reference numerals and symbols as those employed when describing the information processing apparatus 10 of the first embodiment.

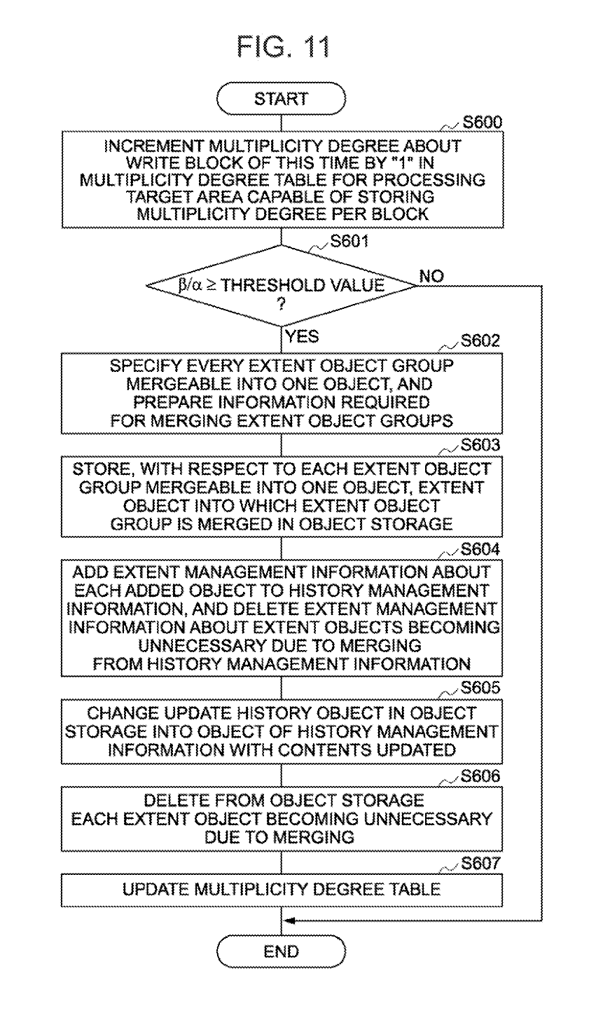

FIG. 11 illustrates a flowchart of the merge process executed by the file system 20 (which will hereinafter be termed the fourth file system 20) within the information processing apparatus 10 according to the fourth embodiment.

As illustrated in FIG. 11, the fourth file system 20 starting this merge process, to begin with, increments a multiplicity degree of each write block of this time by “1” in a multiplicity degree table that can be stored with the multiplicity degrees on the block-by-block basis for the processing target area (step S600).

The multiplicity degree table is defined as “a table that can be stored with the multiplicity degrees with respect to the individual blocks within one area” (the information group on the RAM) managed by the fourth file system 20 per area (and file). Note that the multiplicity degree of a certain block connotes an extent object count of the extent objects retaining the data of the block. Further, the fourth file system 20, when writing the data in a certain area for the first time, prepares the multiplicity degree table stored with “0” as each multiplicity degree about this area. Moreover, when rebooting the information processing apparatus 10, the fourth file system 20, on the occasion of acquiring the update history information on a certain area for the first time after rebooting, obtains the multiplicity degree of each block by analyzing the acquired update history information, and prepares the multiplicity degree table stored with the value obtained as each multiplicity degree.

The fourth file system 20 finishing the process in step S600 determines whether or not anyone of the multiplicity degrees with their values being updated is a multiplicity degree threshold value (e.g., 10) set in the self-system 20 by the administrator etc (step S601).

If any multiplicity degree is not equal to or larger than the multiplicity degree threshold value (step S601; NO), the fourth file system 20 terminates this merge process without executing any process particularly.

Whereas if any one of multiplicity degrees is equal to or larger than the multiplicity degree threshold value (step S601; YES, the fourth file system 20 executes the same processes in steps S602-S606 as those in steps S302-S306 (FIG. 7).

Thereafter, the fourth file system 20 updates the multiplicity degree table related to the processing target area into a table representing the present status (in which the multiplicity degree about each block is “0” or “1”) (step S607), and thereafter finishes this merge process.

As described above, the information processing apparatus 10 (the file system 20) according to the fourth embodiment is different from the information processing apparatus 10 (the file system 20) according to the first embodiment in terms of only the contents of the merge process. Then, the merge process having the contents/procedure depicted in FIG. 11 can also prevent the storage capacity of the storage 50 from being used with the excessive futility. It can be therefore said that the information processing apparatus 10 (the file system 20) according to the fourth embodiment exhibits the same operational effects as those of the information processing apparatus 10 (the file system 20) according to the first embodiment.

### Fifth Embodiment

An information processing apparatus according to a fifth embodiment of the present invention is an apparatus configured to replace the file system 20 within the information processing apparatus 10 according to the first embodiment with what executes the merge process having contents different from those described above. Therefore, the following discussion will explain only the contents of the merge process executed by the file system 20 within the information processing apparatus 10 according to the fifth embodiment by use the same reference numerals and symbols as those employed when describing the information processing apparatus 10 of the first embodiment.

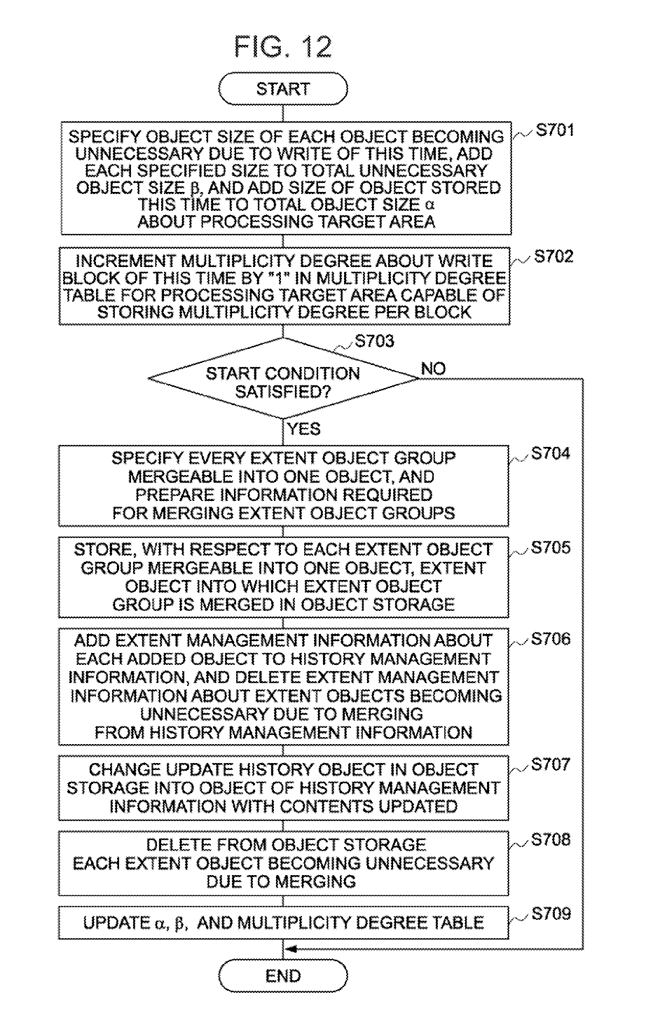

FIG. 12 illustrates a flowchart of the merge process executed by the file system 20 (which will hereinafter be termed the fifth file system 20) within the information processing apparatus 10 according to the fifth embodiment.

As depicted in FIG. 12, the fifth file system 20 starting this merge process, at first, conducts in step S701 the process having the same content as that of the process executed by the third file system 20 in step S500 (FIG. 10).

Subsequently, the fifth file system 20 executes in step S702 the process having the same content as that of the process executed by the fourth file system 20 in step S600 (FIG. 11).

In short, the fifth file system 20 executes, when in the merge process, at first the process of updating the total object size α, the total unnecessary object size β and the multiplicity degree table about the processing target area into those representing the present status (steps S701, S702).

Subsequently, the fifth file system 20 determines whether a starting condition is satisfied or not (step S703).

Herein, the starting condition is a condition that any one of conditions 1-4 is satisfied. These conditions are given as follows:

Condition 1: extent count extent count threshold value;

Condition 2: β≧total unnecessary object size threshold value;

Condition 3: β/α≧ratio threshold value; and

Condition 4: any one of multiplicity degrees≧multiplicity degree threshold value.

Note that each of the extent count threshold value, the total unnecessary object size threshold value, the ratio threshold value and the multiplicity degree threshold value is the information set for the fifth file system 20 by operating the input device of the information processing apparatus 10.

Then, the fifth file system 20, if the starting condition is not satisfied (step S703; NO), finishes this merge process without executing any process particularly.

Whereas if the starting condition is satisfied (step S703; YES), i.e., if anyone of the conditions 1-4 is satisfied, the fifth file system 20 executes the same processes in steps S703-S707 as those in steps S302-S306 (FIG. 7).

Then, the fifth file system 20 finishing the process in step S707, updates the values α, β and the update multiplicity degree table about the processing target area into those representing the present status (step S709), and thereafter terminates this merge process.

As obvious from the description made so far, the information processing apparatus 10 (the file system 20) according to the fifth embodiment has a larger number of conditions for starting the processes (the actual merge process) in steps S703 S708 than the information processing apparatus 10 (the file system 20) according to each of other embodiments has. It can be therefore said that the information processing apparatus 10 (the file system 20) according to the fifth embodiment is the apparatus (program) configured not to cause any particular problem even if some number of threshold values are set to excessively large values.

<Modified Mode>>

The information processing apparatus 10 (the file system 20) according to each of the embodiments can be modified in a variety of forms.

For instance, the information processing apparatus 10 (the file system 20) according to each embodiment can be modified into an apparatus (program) in which after rewriting the update history object in the storage 50, the extent object is stored on the storage 50. When the information processing apparatus 10 (the file system 20) according to each embodiment is modified in this way, however, if disabled from accessing the storage 50 for some reason immediately after rewriting the update history object, such a status, it follows, occurs that the extent object, which is to exist in the update history object (the update history information), does not exist on the storage 50. On the other hand, if configured to rewrite the update history object after storing the extent object and even if disabled from accessing the storage 50 immediately after storing the extent object, the status described above does not occur. It is therefore desirable that the sequence of storing the extent object and rewriting the update history object is set the same as the sequence in each of the embodiments.

Furthermore, the information processing apparatus 10 (the file system 20) according to each embodiment can be also modified into an apparatus in which the update history information related to each area (and each file) is stored within the information processing apparatus 10. If modified in this way, however, there arises a necessity of setting the update history information not to be lost. Accordingly, as in each embodiment, a better option is that the update history information is also stored on the storage 50 as the object.

Further, the extent management information may be sufficient if containing the items of information making recognizable the file name of the associated extent object, the storage sequence of the extent object on the storage 50 and which part of the processing target file has the very data mapped to the object, i.e., the extent object. The information processing apparatus 10 (the file system 20) according to each embodiment can be therefore modified into an apparatus (program) configured to determine the file name of the extent object irrespective of the SEQ number and to add the extent management information containing the determined file name to the update history information (the update history information object).

Further, the information processing apparatus 10 (the file system 20) according to the fourth embodiment can be also modified into an apparatus configured to manage a multiplicity degree allowance value corresponding to “multiplicity degree threshold value−multiplicity degree” per block (and file) and to start the processes from step S602 onward when the multiplicity degree allowance value of a certain block comes to “0”.

The file system 20 according to each embodiment can be also modified into a program (the program etc having the function as the application 35) running in the user space. Moreover, it is a matter of course to add modifications different from those described in this section to the contents (procedures) of the write request response process/read request response process/merge process.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a write request response unit to store, each time there is given partial data constituting a part of a processing target file that is to be stored on an object storage, this partial data as a new object on the object storage, and to add object management information containing data extent information indicating a position and a size of the partial data within the processing target file, name information representing an object name of the new object and storage sequence information indicating a storage sequence of the new object on the object storage to update history information related to the processing target file; and
a read request response unit to read and output, each time there is given readout target extent information indicating a position and a size, within the processing target file, of the readout target data constituting a part of the processing target file that is to be read from the object storage, readout target data from the object storage on the basis of the readout target extent information and each object management information in the update history information related to the processing target file.

2. The information processing apparatus according to claim 1, wherein the write request response unit stores the object storage with the partial data as a new object containing storage sequence information in its name, which indicates a storage sequence on the object storage, and adds object management information containing none of the name information to the update history information related to the processing target file.

3. The information processing apparatus according to claim 1, wherein the write request response unit adds, after storing the partial data as the new data on the object storage, the object management information to the update history information related to the processing target file.

4. The information processing apparatus according to claim 1, wherein the write request response unit, each time the partial data is given, reads the update history information related to the processing target file that is stored as the object from the object storage, adds the object management information to the readout update history information, and thereafter rewrites the object about the update history information related to the processing target file within the object storage into an object about the update history information receiving the addition of the object management information, and
the read request response unit, each time the read target extent information is given, reads the update history information related to the processing target file that is stored as the object from the object storage, and reads and outputs the readout target data from the object storage on the basis of the given readout target extent information and each object management information in the readout update history information.

5. The information processing apparatus according to claim 1, further comprising:
a merge processing unit to try specifying a plurality of objects stored on the object storage and containing data in the same extent within the processing target file on the basis of the update history information related to the processing target file, to store, if the plurality of objects containing the data in the same extent within the processing target file can be specified, an object merged with the plurality of objects on the object storage and to delete the specified objects from the object storage, and to execute a process of erasing the object management information related to the specified objects from the update history information related to the processing target file and a process of adding the object management information about the object merged with the plurality of objects to the update history information related to the processing target file.

6. The information processing apparatus according to claim 5, wherein the merge processing unit functions when number of the object management information in the update history information related to the processing target file is equal to or larger than a specified value.

7. The information processing apparatus according to claim 5, wherein the merge processing unit functions when a total size of data becoming unnecessary due to storage of updated data is equal to or larger than a specified size.

8. The information processing apparatus according to claim 5, wherein the merge processing unit functions when a ratio of a total size of data becoming unnecessary due to storage of updated data to a total size of stored objects is equal to or larger than a specified ratio.

9. The information processing apparatus according to claim 5, wherein the merge processing unit functions when number of objects containing same data is equal to or larger than a specified ratio.

10. A data storage method executed by a computer, the method comprising:
storing, each time there is given partial data constituting a part of a processing target file that is to be stored on an object storage, this partial data as a new object on the object storage; and
adding object management information containing data extent information indicating a position and a size of the partial data within the processing target file, name information representing an object name of the new object and storage sequence information indicating a storage sequence of the new object on the object storage to update history information related to the processing target file.

11. A computer-readable recording medium having stored therein a program for causing a computer to execute:
a write request response process of storing, each time there is given partial data constituting a part of a processing target file that is to be stored on an object storage, this partial data as a new object on the object storage, and adding object management information containing data extent information indicating a position and a size of the partial data within the processing target file, name information representing an object name of the new object and storage sequence information indicating a storage sequence of the new object on the object storage to update history information related to the processing target file; and
a read request response process of reading and outputting, each time there is given readout target extent information indicating a position and a size, within the processing target file, of the readout target data constituting a part of the processing target file that is to be read from the object storage, readout target data from the object storage on the basis of the readout target extent information and each object management information in the update history information related to the processing target file.
